(19) United States
(12) Patent Application Publication
(10) Pub. No.: US 2011/0047749 A1
(43) Pub. Date: Mar. 3, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/580,276

(22) Filed: Oct. 16, 2009

(30) Foreign Application Priority Data
Aug. 27, 2009 (CN) 200920309039.6

(51) Int. Cl. E05F 1/08; E05D 11/10

(52) U.S. Cl. 16/297; 16/277

(57) ABSTRACT

A hinge includes a rack, a bracket rotatably surrounding the rack, and a mounting member in tight contact with a side opposite to the rack of the bracket. The mounting member defines two opposite curved through slots. A resilient portion is formed between each through slot and an edge of the mounting member. A locating block extends from the resilient portion to engage the bracket, to deform the resilient portions of the mounting member generating elastic force to bias the mounting member onto the bracket, which stabilizes the hinge.

### CROSS-REFERENCE TO RELATED APPLICATION

The relevant subject matter is disclosed in a co-pending U.S. patent application (Attorney Docket No. US27859) filed on the same date and entitled “HINGE”, which is assigned to the same assignee as this patent application.

### BACKGROUND

1. Technical Field

The disclosure relates to hinges, and particularly to a bidirectional hinge.

2. Description of Related Art

Collapsible devices, such as notebook computers and clamshell mobile phones, generally include a main body and a cover, often interconnected by a hinge. The hinge allows the cover to rotate with respect to the main body, and collapse with the main body for saving space.

A bidirectional hinge normally includes a horizontal pivot structure and an upright pivot structure. The horizontal pivot structure allows the cover to be rotatable with respect to the main body along a horizontal axis. The upright pivot structure allows the cover to be rotatable with respect to the main body along an upright axis. However, such upright pivot structures are often unstable, leading to unsteadiness of the cover.

### BRIEF DESCRIPTION OF THE DRAWINGS

FIG. 1 is an exploded, isometric view of an exemplary embodiment of a hinge.

FIG. 2 is an inverted view of FIG. 1.

FIG. 3 is an assembled, isometric view of the hinge of FIG. 1.

FIG. 4 is an assembled, isometric view of the hinge of FIG. 2.

### DETAILED DESCRIPTION

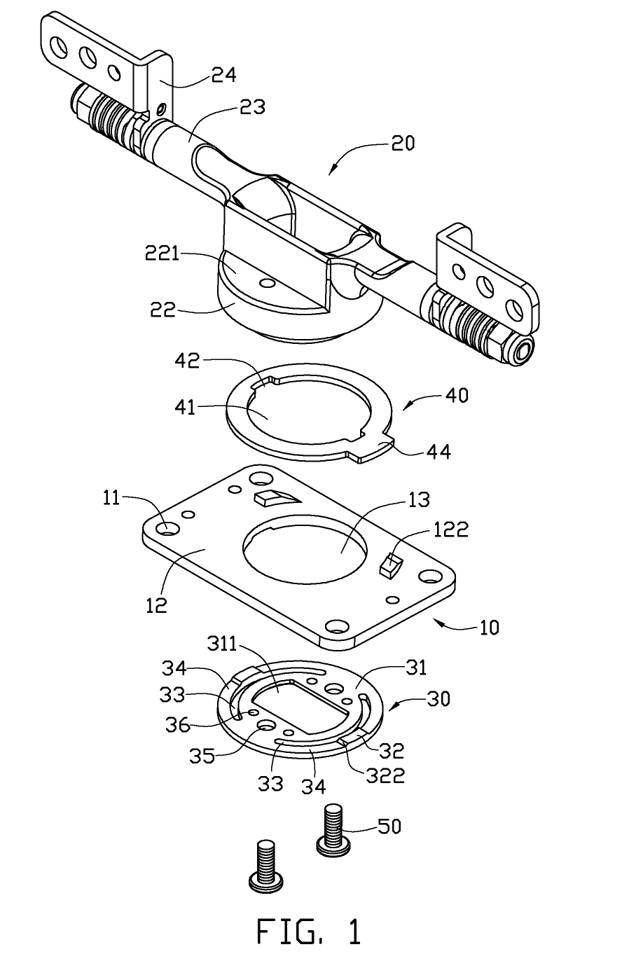

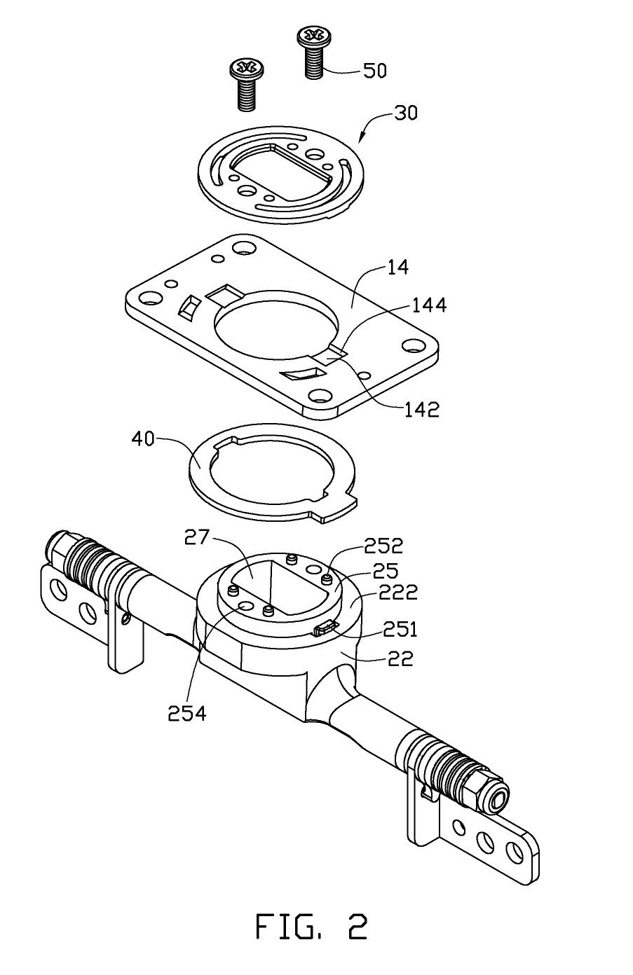

Referring to FIGS. 1 and 2, an exemplary embodiment of a hinge is disclosed. The hinge is mounted on a collapsible device (not shown), such as a notebook computer or clamshell mobile phone, rotatably connecting two parts. The hinge includes a bracket 10, a rack 20, a mounting member 30, a stopping member 40, and two fasteners 50. In this embodiment, the fasteners 50 are bolts.

The bracket 10 is a plate, and includes a first side 12 and a second side 14, opposite to each other. The bracket 10 defines four mounting holes 11 in four corners thereof, for mounting the bracket 10 to one part of the collapsible device. The bracket 10 further defines a pivot hole 13 in a center thereof. Two blocks 122 are formed on the first side 12, opposite to each other from across the pivot hole 13. The second side 14 defines two opposite depressed portions 142, in communication with the pivot hole 13. Each depressed portion 142 forms two inclined surfaces 144 connected to opposite ends of a bottom of the depressed portion 142 and the second side 14, respectively.

The rack 20 is generally T-shaped, and includes a main body 22, and two opposite shafts 23 extending from a first side 221 thereof. A mounting piece 24 is mounted on each shaft 23. The mounting pieces 24 are fixed to the other part of the collapsible device. A pivot portion 25 is formed on a second side 222 opposite to the first side 221 of the main body 22. A center hole 27 is defined in a center of an end surface of the pivot portion 25. The main body 22 forms two tabs 251, joining to a circumference of the pivot portion 25. A plurality of posts 252 extends from the circumference of the pivot portion 25, beside the center hole 27. Two mounting holes 254 are defined in the end surface of the pivot portion 25, beside the center hole 27.

The mounting member 30 is generally a disc. The mounting member 30 defines a through hole 311 in a center of the mounting member 30, and two curved through slots 33 around the through hole 311. A resilient portion 34 is formed on the mounting member 30, opposite to the through hole 311 relative to each through slot 33. A locating block 32 protrudes from each resilient portion 34, at a side 31 of the mounting member 30. Two angled surfaces 322 are formed at opposite ends of each locating block 32, smoothly transitioning to the side 31. Two holes 35 and a plurality of limiting holes 36 are defined in the mounting member 30 around the through hole 311.

The stopping member 40 is generally annular. The stopping member 40 defines a round through hole 41 in a center of the stopping member 40. Two opposite cutouts 42 are defined in the stopping member 40, communicating with the through hole 41. A stopping portion 44 extends outward from an edge of the stopping member 40.

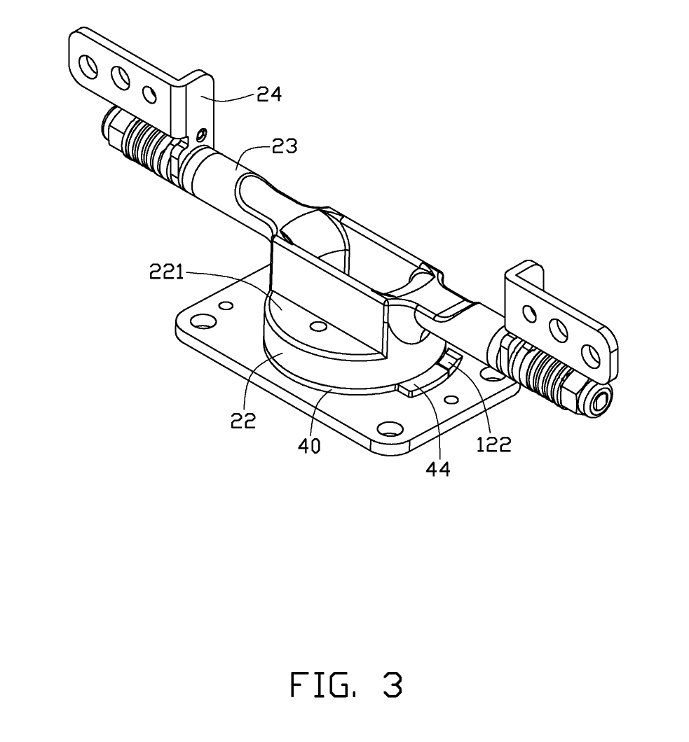

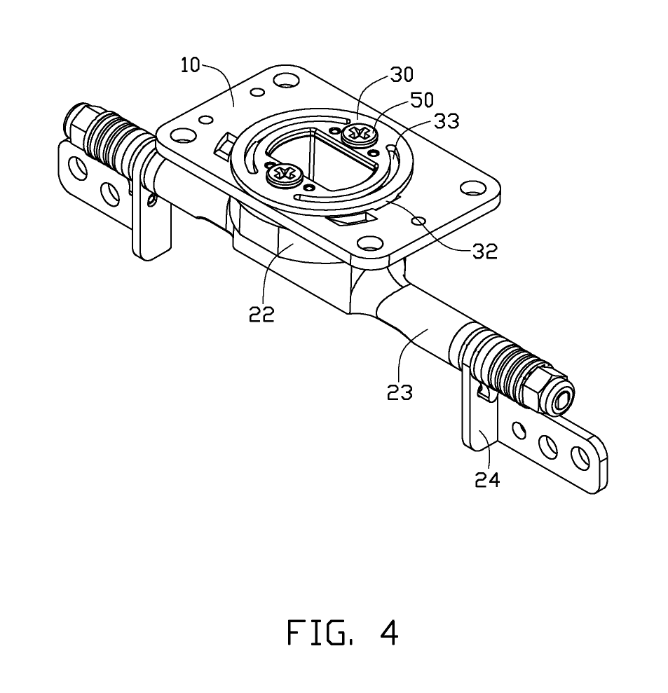

Referring to FIGS. 3 and 4, during assembly, the stopping member 40 is set around the pivot portion 25 of the rack 20. The tabs 251 of the pivot portion 25 engage the cutouts 42 of the stopping member 40, respectively. The bracket 10 is set around the pivot portion 25 of the rack 20 via the pivot hole 13, with the first side 12 facing the rack 20. The mounting member 30 is in tight contact with the second side 14 of the bracket 10. The plurality of posts 252 of the pivot portion 25 engage the plurality of limiting holes 36 of the mounting member 30, respectively. The fasteners 50 extend through the holes 35 of the mounting member 30 and are received in the mounting holes 254 of the rack 20, respectively. The resilient portions 34 of the mounting member 30 are deformed by the bracket 10, generating elastic force to bias the mounting member 30 onto the bracket 10.

In use, when one part of the collapsible device rotates with respect to the other part of the collapsible device along an upright axis, the rack 20 rotates with respect to the bracket 10. The pivot portion 25 of the rack 20 rotates in the pivot hole 13 of the bracket 10, to rotate the mounting member 30 and the stopping member 40 with respect to the bracket 10. The locating blocks 32 of the mounting member 30 engage the depressed portions 142 of the bracket 10, respectively, locating the mounting member 30 relative to the bracket 10. The locating blocks 32 of the mounting member 30 are released from the depressed portions 142 of the bracket 10, respectively, by the inclined surfaces 144 biasing the angled surfaces 322. The stopping portion 44 of the stopping member 40 engages one of the blocks 122 of the bracket 10 to limit movement of the rack 20.

In this embodiment, the locating blocks 32 engage the second side 14 of the bracket 10 to deform the resilient portions 34 of the mounting member 30, thereby generating elastic force to bias the mounting member 30 onto the bracket 10, stabilizing the hinge.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a bracket;
a rack comprising a pivot portion around which the bracket is rotatable;
a mounting member in tight contact with a side opposite to the rack of the bracket, and comprising two opposite resilient members, each resilient member comprising a locating block; and
a fastener extending through the mounting member and the bracket and received in the rack;
wherein the locating blocks of the mounting member engage the bracket to deform the resilient portions of the mounting member, generating elastic force to bias the mounting member onto the bracket.

2. The hinge of claim 1, further comprising a stopping member fixed to the rack, the stopping member comprising a stopping portion, two blocks on the bracket, with one of which the stopping portion of the stopping member is engagable, thereby limiting movement of the rack relative to the bracket.

3. The hinge of claim 2, wherein the stopping member defines a round through hole surrounding the pivot portion of the rack, two cutouts communicating with the round through hole, and wherein the pivot portion of the rack comprises two tabs for engaging the cutouts of the stopping member, respectively.

4. The hinge of claim 1, wherein the mounting member defines a plurality of limiting holes and a plurality of posts extending from the pivot portion for engaging the plurality of limiting holes, respectively.

5. The hinge of claim 1, wherein the mounting member defines a through hole in a center of the mounting member, and two curved through slots around the through hole, wherein each resilient portion is formed between a corresponding through slot and the edge of the mounting member.

6. The hinge of claim 1, wherein the resilient portions of the mounting member are formed at opposite edges of the mounting member, and the locating blocks extend from the corresponding resilient portions for engaging the bracket.

7. The hinge of claim 6, wherein two depressed portions are defined in the bracket, in which the locating blocks of the mounting member are engagable, respectively, for locating the rack relative to the bracket.

8. The hinge of claim 7, wherein each depressed portion forms two inclined surfaces at opposite ends, each locating block forms two angled surfaces at opposite ends, and the locating blocks of the mounting member are operable to be released from the depressed portions of the bracket, respectively, via the inclined surfaces biasing the angled surfaces.

9. A hinge, comprising:
a rack;
a bracket rotatably surrounding the rack; and
a mounting member in tight contact with a side opposite to the rack of the bracket, the mounting member defining two opposite curved through slots, a resilient portion formed between a corresponding through slot and an edge of the mounting member, wherein each resilient portion forms a locating block;
wherein the locating blocks of the mounting member engage the bracket to deform the resilient portions of the mounting member, generating elastic force to bias the mounting member onto the bracket.

10. The hinge of claim 9, further comprising a stopping member fixed to the rack, wherein the stopping member comprises a stopping portion, and two blocks are formed on the bracket, with one of which the stopping portion of the stopping member is engagable, for limiting movement of the rack relative to the bracket.

11. The hinge of claim 10, wherein the stopping member defines a round through hole surrounding the pivot portion of the rack, two cutouts are defined in the stopping member, communicating with the round through hole, the pivot portion of the rack comprising two tabs for engaging the cutouts of the stopping member.

12. The hinge of claim 9, wherein the mounting member defines a plurality of limiting holes, a plurality of posts extending from the pivot portion for engaging the plurality of limiting holes, respectively.

13. The hinge of claim 9, wherein a fastener extends through the mounting member and the bracket and is received in the rack.

14. The hinge of claim 9, wherein the mounting member defines a through hole in the center thereof, around which the curved through slots are dispoased.

15. The hinge of claim 9, wherein two depressed portions are defined in the bracket, in which the locating blocks of the mounting member are engagable, respectively, for locating the rack relative to the bracket.

16. The hinge of claim 15, wherein each depressed portion forms two inclined surfaces at opposite ends thereof, each locating block forms two angled surfaces at opposite ends thereof, and the locating blocks of the mounting member are operable to be released from the depressed portions of the bracket, respectively, via the inclined surfaces biasing the angled surfaces.
